(19) United States
(12) Patent Application Publication
(10) Pub. No.: US 2026/0158779 A1
(43) Pub. Date: Jun. 11, 2026

(54) LIQUID DROPLET EJECTION APPARATUS

(71) Applicant: BROTHER KOGYO KABUSHIKI KAISHA, Nagoya (JP)

(72) Inventors: Yuya KATO, Nagoya (JP); Haruhisa TAKAYAMA, Nagoya (JP); Atsushi ITO, Nagoya (JP)

(73) Assignee: BROTHER KOGYO KABUSHIKI KAISHA, Nagoya (JP)

(21) Appl. No.: 19/361,782

(22) Filed: Oct. 17, 2025

(30) Foreign Application Priority Data
Dec. 11, 2024 (JP) 2024-216945

(51) Int. Cl. B41J 2/045; B41J 29/00; G01V 8/12

(52) U.S. Cl. CPC B41J 2/04561; B41J 2/0451; B41J 2/04581; B41J 2/04593; B41J 29/00; G01V 8/12

(57) ABSTRACT

An ejection head includes a nozzle surface facing in a first direction. A light source includes an emission surface facing in an optical axis direction crossing the first direction. A light sensor includes a light reception surface configured to detect an amount of light that is emitted from the light source and passes through a flying space. A controller is configured to perform an ejection malfunction detection of detecting an amount of light by the light sensor when the liquid droplet is ejected from the ejection head and light is emitted from the light source, and detecting an ejection malfunction of the nozzle based on the amount of light detected by the light sensor. The light reception surface is inclined to face in an inclination direction with respect to a state where the emission surface and the light reception surface face each other without inclination.

### REFERENCE TO RELATED APPLICATIONS

This application claims priority from Japanese Patent Application No. 2024-216945 filed on Dec. 11, 2024. The entire content of the priority application is incorporated herein by reference.

### BACKGROUND ART

A liquid droplet ejection apparatus that ejects liquid droplets such as ink droplets is known.

### SUMMARY

For example, a liquid ejection malfunction detection device includes an ejection head having a nozzle, a light emitting element, and a light receiving element. In this liquid ejection malfunction detection device, the light receiving element is disposed to face the light emitting element without inclination.

However, light emitted from the light emitting element may be reflected by the light receiving element, and the reflected light may enter the light emitting element. Thus, the oscillation mode of the light source may be discretely changed (that is, the wavelength may be discretely changed) by the reflected light being incident on the light source. Thus, a problem may occur that the voltage output by the light receiving element having wavelength dependence changes due to the wavelength, and thus noise is included.

In view of the foregoing, an example of an object of this disclosure is to provide a liquid droplet ejection apparatus configured to reduce an erroneous determination of an ejection malfunction.

According to one aspect, this specification discloses a liquid droplet ejection apparatus. The liquid droplet ejection apparatus includes an ejection head, a light source, a light sensor, and a controller. The ejection head includes a nozzle surface facing in a first direction. The nozzle surface includes a nozzle configured to eject a liquid droplet. The light source includes an emission surface facing in an optical axis direction crossing the first direction. The emission surface is configured to emit light toward a flying space in which the liquid droplet ejected from the nozzle flies. The light sensor includes a light reception surface. The light reception surface is configured to detect an amount of light that is emitted from the light source and passes through the flying space. The controller is configured to perform an ejection malfunction detection. The ejection malfunction detection includes detecting an amount of light by the light sensor when the liquid droplet is ejected from the ejection head and light is emitted from the light source. The ejection malfunction detection includes detecting an ejection malfunction of the nozzle based on the amount of light detected by the light sensor. The light reception surface is inclined to face in an inclination direction with respect to a state where the emission surface and the light reception surface face each other without inclination.

According to the present disclosure, the reflected light, which is the light emitted from the light source and reflected by the light reception surface, entering the light source is reduced. This reduces the reflected light that enters the light source, and thus reduces the likelihood that the oscillation mode of the light source changes discretely (that is, the wavelength changes discretely). Thus, the voltage output by the light sensor having wavelength dependence includes less noise that is generated due to a change caused by the change in the wavelength. Thus, the ejection malfunction detection process of the nozzle is performed based on the voltage in which the noise is reduced, which is output by the light sensor. Thus, erroneous determination of an ejection malfunction is less likely to occur.

### BRIEF DESCRIPTION OF DRAWINGS

FIG. 1 is a plan view showing a liquid droplet ejection apparatus.

FIG. 2 is a cross-sectional view showing the structure of an ejection head shown in FIG. 1.

FIG. 3 is a block diagram showing the components of a printing apparatus including the liquid droplet ejection apparatus shown in FIG. 1.

FIG. 4 is a diagram showing a mode in which a laser light is irradiated onto an ink droplet that is being ejected from an ejection head and is flying.

FIG. 5 is a view showing a mode in which a light reception surface of a first detection element is inclined with respect to an emission surface of a light source.

FIG. 6A is a diagram showing an example of an effective light reception surface of a light reception surface viewed from an emission surface side when the light reception surface is not inclined.

FIG. 6B is a diagram showing an example of an effective light reception surface of the light reception surface viewed from the emission surface side when the light reception surface is inclined at a particular angle in a second direction.

FIG. 7A is a graph showing a relationship between an effective light receiving area of the light reception surface and an inclination angle of the light reception surface.

FIG. 7B is a graph showing a relationship between an amount of deviation of the reflected light and the inclination angle of the light reception surface.

FIG. 8 is a graph showing an example of a relationship between a wavelength of laser light, which is output light output by the light source, and time.

FIG. 9A is a graph showing an example of a relationship between a signal output by a second detection element and time.

FIG. 9B is a graph showing an example of the relationship between a signal output by a first detection element and time.

FIG. 10 is a diagram showing a correction table in which correction amounts for a correction process are stored for each state.

FIG. 11 is a flowchart showing an example of a process including a grouping process.

FIG. 12 is a block diagram showing a configuration of a signal amplification unit.

FIG. 13 is a flowchart showing an example of an ink droplet ejection process.

### DESCRIPTION

Hereinafter, a liquid droplet ejection apparatus according to an embodiment of the present disclosure will be described with reference to the drawings. The liquid droplet ejection apparatus described below is merely an embodiment of the present disclosure. Thus, the present disclosure is not limited to the following embodiments, and additions, deletions, and modifications may be made without departing from the spirit of the present disclosure.

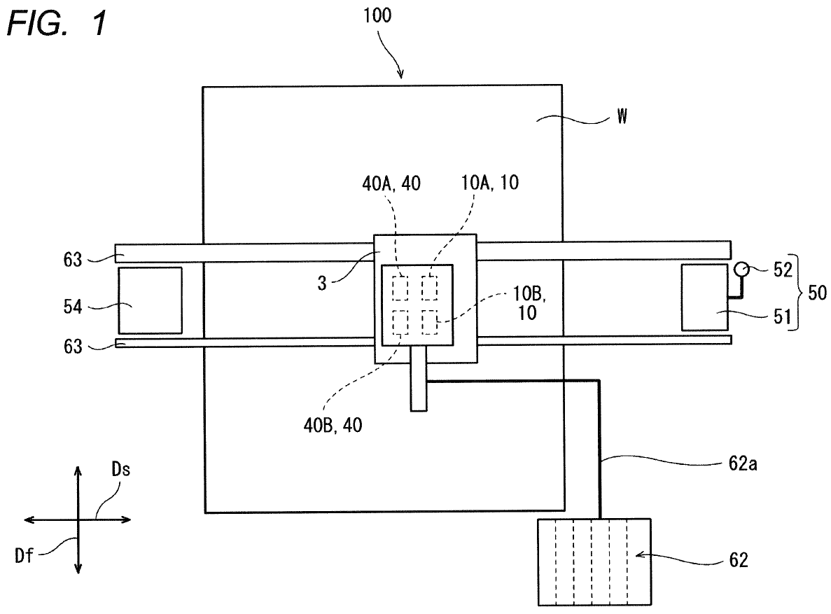

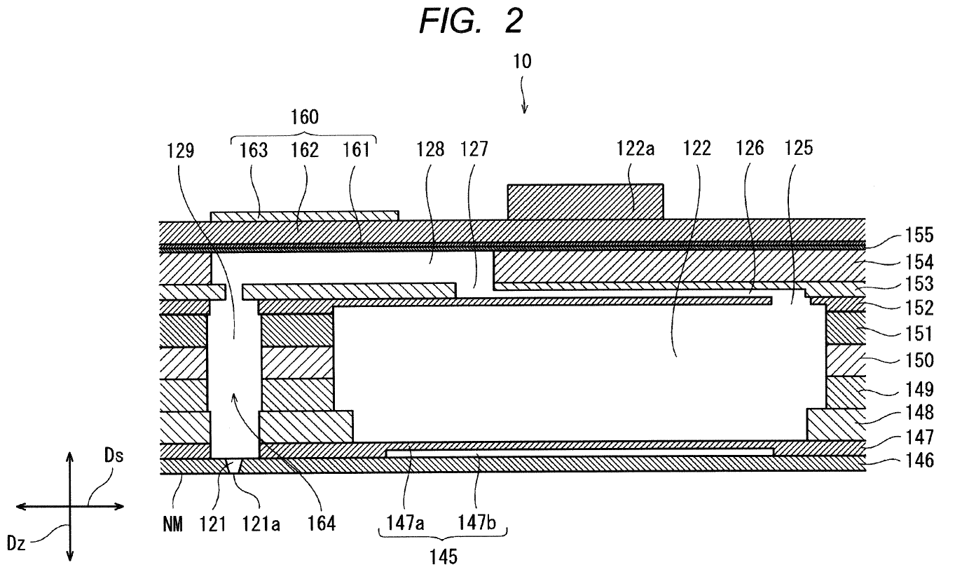

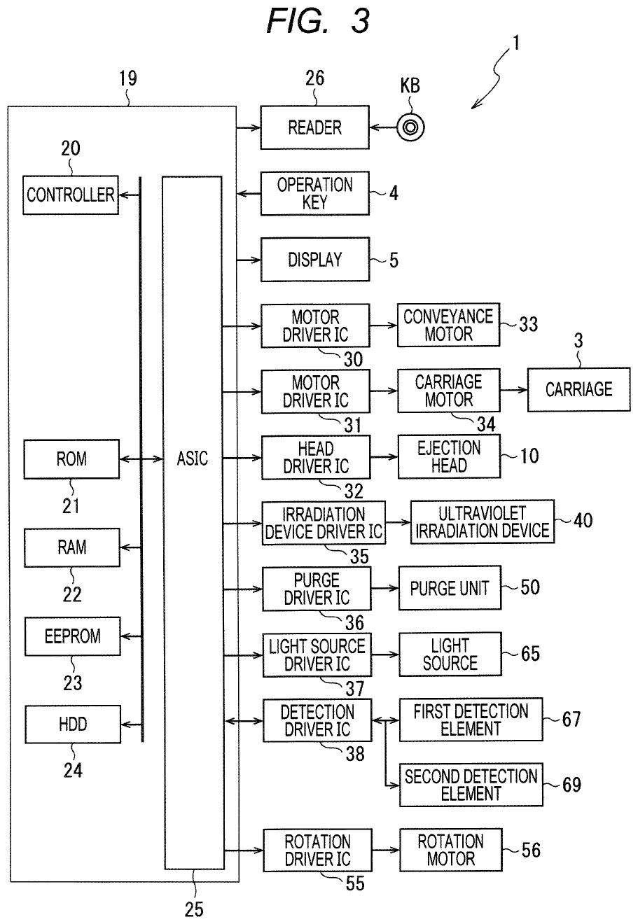

FIG. 1 shows a liquid droplet ejection apparatus 100 according to an embodiment of the present disclosure. FIG. 2 shows the configuration of an ejection head 10 in FIG. 1. FIG. 3 shows components of a printing apparatus 1 including the liquid droplet ejection apparatus 100 of FIG. 1. In FIGS. 1 and 2, directions perpendicular to each other are defined as a movement direction Ds, a conveyance direction Df, and a vertical direction Dz. In the present embodiment, for example, the movement direction Ds is a movement direction of a carriage 3 described later, the conveyance direction Df is a conveyance direction of a print medium W described later, and the vertical direction Dz is an upper-lower direction.

As shown in FIGS. 1 and 3, the liquid droplet ejection apparatus 100 includes, for example, two ejection heads 10 (10A, 10B), two ultraviolet (UV) light irradiation devices 40 (40A, 40B), a carriage 3 on which the ejection heads 10 and the ultraviolet light irradiation devices 40 are mounted, a storage tank 62, a pair of guide rails 63, and a controller unit 19 including a controller 20. In the present embodiment, an inkjet head that ejects ultraviolet curable ink droplets is illustrated as the ejection head 10. In the present embodiment, ink droplets are an example of liquid droplets.

The carriage 3 is supported by the pair of guide rails 63 extending in the movement direction Ds, and reciprocates in the movement direction Ds along the guide rails 63. Accordingly, the two ejection heads 10 (10A and 10B) and the two ultraviolet light irradiation devices 40 (40A and 40B) reciprocate in the movement direction Ds. The ejection head 10 is connected to the storage tank 62 via a tube 62a.

In the present embodiment, the ejection head 10A ejects ink droplets of respective colors of cyan (C), magenta (M), yellow (Y), and black (K), which are collectively referred to as color ink, for example. The ink droplets of the four colors are ejected onto the print medium W supported by a platen (not shown), thereby printing a color image on the print medium W. The ejection head 10B ejects, for example, white (W) ink droplets and clear (Cr) ink droplets. When a color image is printed on, for example, a fabric as the print medium W, ink droplets of white ink are first ejected as base ink, and ink droplets of color ink are ejected on the ink droplets of white ink, in order to reduce the influence on the color of the fabric and the material of the fabric. The ink droplets of the clear ink are ejected when gloss is to be applied or when a printed portion is to be protected.

The storage tank 62 stores ink. The storage tank 62 is provided for each type of ink. For example, six storage tanks 62 are provided, and black, yellow, cyan, magenta, white, and clear inks are stored in the storage tanks 62, respectively.

The liquid droplet ejection apparatus 100 further includes a purge unit 50 and a receiving unit 54. The receiving unit 54 is disposed on one end side of the pair of guide rails 63 in the movement direction Ds so as to overlap a movement region of the carriage 3. The purge unit 50 is disposed on the other end side of the pair of guide rails 63 in the movement direction Ds so as to overlap the movement region of the carriage 3.

The purge unit 50 includes a cap 51, a suction pump 52, and a lifting mechanism (not shown) that lifts and lowers the cap 51 between a suction position and a standby position. The suction pump 52 is connected to the cap 51. At the standby position, a nozzle surface NM in FIG. 2 is separated from the cap 51. At the suction position, the nozzle surface NM is covered with the cap 51, and a sealed space is formed. When the cap 51 is at the suction position, the suction pump 52 is driven to suck the sealed space, thereby performing a purge process of discharging ink from a nozzle hole 121a shown in FIG. 2. The receiving unit 54 receives ink droplets ejected from the ejection head 10 by a flushing process. The ink ejected by the purge process and the ink ejected by the flushing process are discarded.

As shown in FIG. 2, the ejection head 10 has a plurality of nozzles 121 that eject ink droplets by using ink from the storage tank 62. The ejection head 10 has a laminated body of a channel (flow path) forming body and a volume changing portion. The channel forming body has an ink channel formed therein, and a plurality of nozzle holes 121a are opened in the nozzle surface NM which is a lower surface of the channel forming body. The volume changing portion is driven to change the volume of the ink channel. At this time, a meniscus is vibrated at the nozzle hole 121a and ink is ejected.

The channel forming body of the ejection head 10 is a laminate of a plurality of plates, and the volume changing portion includes a vibration plate 155 and an actuator (piezoelectric element) 160. A common electrode 161 is connected to the top of the vibration plate 155.

The plurality of plates are stacked to include, in order from the bottom, a nozzle plate 146, a spacer plate 147, a first channel plate 148, a second channel plate 149, a third channel plate 150, a fourth channel plate 151, a fifth channel plate 152, a sixth channel plate 153, and a seventh channel plate 154.

Each plate has a variety of holes and grooves, large and small. In the channel forming body in which the plates are stacked, the holes and the grooves are combined, and the plurality of nozzles 121, a plurality of individual channels 164, and a manifold 122 are formed as ink channels.

The nozzle 121 is formed through the nozzle plate 146 in the stacking direction. The plurality of nozzle holes 121a, which are the tips of the nozzles 121, are arranged in the conveyance direction Df on the nozzle surface NM of the nozzle plate 146 to form a nozzle array.

The manifold 122 supplies ink to a pressure chamber 128 to which an ejection pressure is applied. The manifold 122 extends in the conveyance direction Df and is connected to one end of each of the plurality of individual channels 164. That is, the manifold 122 functions as a common channel of ink. The manifold 122 is formed by stacking, in the stacking direction, a through hole formed through the first channel plate 148 to the fourth channel plate 151 in the stacking direction and a recess recessed from the lower surface of the fifth channel plate 152.

The nozzle plate 146 is disposed below the spacer plate 147. The spacer plate 147 is formed of, for example, a stainless steel material. The spacer plate 147 has a recess 145 in which a thin portion forming a damper portion 147a and a damper space 147b are formed. The recess 145 is formed by being recessed in the thickness direction of the spacer plate 147 from the surface on the nozzle plate 146 side by, for example, half etching. Accordingly, the damper space 147b as a buffer space is formed between the manifold 122 and the nozzle plate 146.

A supply port 122a is in communication with the manifold 122. The supply port 122a is formed in, for example, a cylindrical shape, and is provided at one end in the conveyance direction Df. The manifold 122 and the supply port 122a are connected to each other through a channel (not shown).

Each individual channel 164 is connected to the manifold 122. The individual channel 164 has an upstream end connected to the manifold 122 and a downstream end connected to a base end of the nozzle 121. The individual channel 164 is constituted by a first communication hole 125, a supply throttle channel 126 as an individual throttle channel, a second communication hole 127, the pressure chamber 128, and a descender 129, and these elements are arranged in this order in the ink supply direction.

The first communication hole 125 has a lower end connected to an upper end of the manifold 122, extends upward in the stacking direction from the manifold 122, and extends through an upper portion of the fifth channel plate 152 in the stacking direction.

The upstream end of the supply throttle channel 126 is connected to the upper end of the first communication hole 125. The supply throttle channel 126 is formed by, for example, half etching, and is constituted by a groove recessed from the lower surface of the sixth channel plate 153. The second communication hole 127 has an upstream end connected to the downstream end of the supply throttle channel 126, extends upward in the stacking direction from the supply throttle channel 126, and extends through the sixth channel plate 153 in the stacking direction.

The upstream end of the pressure chamber 128 is connected to the downstream end of the second communication hole 127. The pressure chamber 128 is formed to extend through the seventh channel plate 154 in the stacking direction.

The descender 129 is formed to extend through the spacer plate 147, the first channel plate 148, the second channel plate 149, the third channel plate 150, the fourth channel plate 151, the fifth channel plate 152, and the sixth channel plate 153 in the stacking direction. The descender 129 has an upstream end connected to the downstream end of the pressure chamber 128 and a downstream end connected to the base end of the nozzle 121. The nozzle 121 overlaps the descender 129 in the stacking direction and is disposed at the center of the descender 129 in the width direction, for example.

The vibration plate 155 is stacked on the seventh channel plate 154, and covers an upper end opening of the pressure chamber 128.

The actuator 160 includes the common electrode 161, a piezoelectric layer 162, and an individual electrode 163, which are arranged in this order. The common electrode 161 covers the entire surface of the vibration plate 155. The piezoelectric layer 162 covers the entire surface of the common electrode 161. The individual electrode 163 is provided for each pressure chamber 128 and is disposed on the piezoelectric layer 162. One actuator 160 is formed by one individual electrode 163, the common electrode 161, and the piezoelectric layer 162 at a portion sandwiched between both electrodes.

The individual electrode 163 is electrically connected to the head driver IC 32 (FIG. 3). The head driver IC 32 receives a control signal from the controller 20, generates a drive signal (voltage signal), and applies the drive signal to the individual electrode 163. In contrast, the common electrode 161 is always held at a ground potential. In such a configuration, the active portion of the piezoelectric layer 162 expands and contracts in the surface direction together with the common electrode 161 and the individual electrode 163 in accordance with the drive signal. In response to this, the vibration plate 155 deforms in cooperation, and changes in a direction in which the volume of the pressure chamber 128 increases or decreases. Accordingly, an ejection pressure for ejecting an ink droplet from the nozzle 121 is applied to the pressure chamber 128.

In the ejection head 10, when ink flows into the manifold 122 through the supply port 122a, the ink flows from the manifold 122 into the supply throttle channel 126 through the first communication hole 125, and flows from the supply throttle channel 126 into the pressure chamber 128 through the second communication hole 127. The ink then flows through the descender 129 and into the nozzle 121. When the actuator 160 applies an ejection pressure to the pressure chamber 128, an ink droplet is ejected from the nozzle hole 121a.

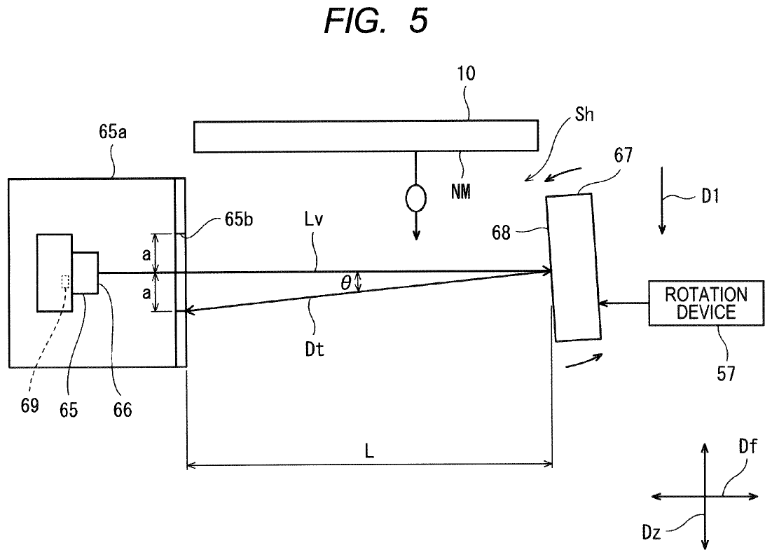

The printing apparatus 1 is, for example, an inkjet printer capable of printing on a print medium W, which is a three-dimensional object. The printing apparatus 1 may be an inkjet printer, for example, that prints on paper. As shown in FIG. 3, the printing apparatus 1 includes an operation key 4, a display 5, and a reader 26. The liquid droplet ejection apparatus 100 includes motor drivers IC 30 and 31, a head driver IC 32, a conveyance motor 33, a carriage motor 34, an irradiation device driver IC 35, a purge driver IC 36, a light source driver IC 37, a detection driver IC 38, and a rotation driver IC 55. The liquid droplet ejection apparatus 100 also includes a rotation device 57 (FIG. 5) described later having a rotation motor 56, a light source 65, a first detection element 67 that detects laser light emitted from the light source 65, and a second detection element 69 that is disposed in the light source 65 and detects laser light emitted from the light source 65. In the present embodiment, the first detection element 67 is an example of a light sensor (light reception unit). For example, the first detection element 67 and the second detection element 69 are photodiodes.

The controller unit 19 includes the controller 20 configured by, for example, a CPU, storage devices (a ROM 21, a RAM 22, an EEPROM 23, an HIDD 24), and an ASIC 25. The controller 20 is connected to the storage devices and controls the driver ICs 30 to 32, 35 to 38, and 55 and the display 5.

The controller 20 performs various functions by executing a particular droplet ejection program stored in the ROM 21. The controller 20 may be implemented as one processor in the controller unit 19, or may be implemented as a plurality of processors that cooperate with each other. More specifically, the “controller” may be implemented as a single processor or a group of multiple processors located either locally or remotely working together or in a distributed fashion to collectively perform the task attributed to the “controller”. The droplet ejection program is read by the reader 26 from a computer-readable magneto-optical disc, for example, or a recording medium KB such as a USB flash memory, and is stored in the ROM 21. The RAM 22 stores image data received from the outside, a calculation result of the controller 20, and so on. The EEPROM 23 stores various types of initial setting information input by the user. The HDD 24 stores various types of information.

The motor driver ICs 30 and 31, the head driver IC 32, the irradiation device driver IC 35, the purge driver IC 36, the light source driver IC 37, the detection driver IC 38, and the rotation driver IC 55 are connected to the ASIC 25. When the controller 20 receives a print job from a user, the controller 20 outputs an image recording command to the ASIC 25 based on the liquid droplet ejection program. The ASIC 25 controls the driver ICs 30 to 32, 35 to 38, and 55 based on the image recording command. The controller 20 drives the conveyance motor 33 by the motor driver IC 30 to move the platen in the conveyance direction Df. Accordingly, the print medium W supported by the platen is conveyed in the conveyance direction Df. The controller 20 moves the carriage 3 in the movement direction Ds by driving the carriage motor 34 by the motor driver IC 31. Accordingly, the ejection head 10 moves in the movement direction Ds.

The controller 20 converts image data acquired from an external device, for example, into ejection data for ejecting ink droplets onto the print medium W. The controller 20 causes the head driver IC 32 to eject ink droplets from the ejection head 10. The controller 20 causes a UV light emitting diode chip included in the ultraviolet light irradiation device 40 to emit UV light by the irradiation device driver IC 35. The controller 20 drives the purge unit 50 by the purge driver IC 36. The controller 20 controls an emission operation of the laser light of the light source 65 by the light source driver IC 37. The controller 20 controls detection operations of the first detection element 67 and the second detection element 69 by the detection driver IC 38, and receives signals output from the first detection element 67 and the second detection element 69. The controller 20 drives the rotation motor 56 of the rotation device 57 by the rotation driver IC 55 to tilt the first detection element 67. The process of tilting the first detection element 67 will be described in detail later.

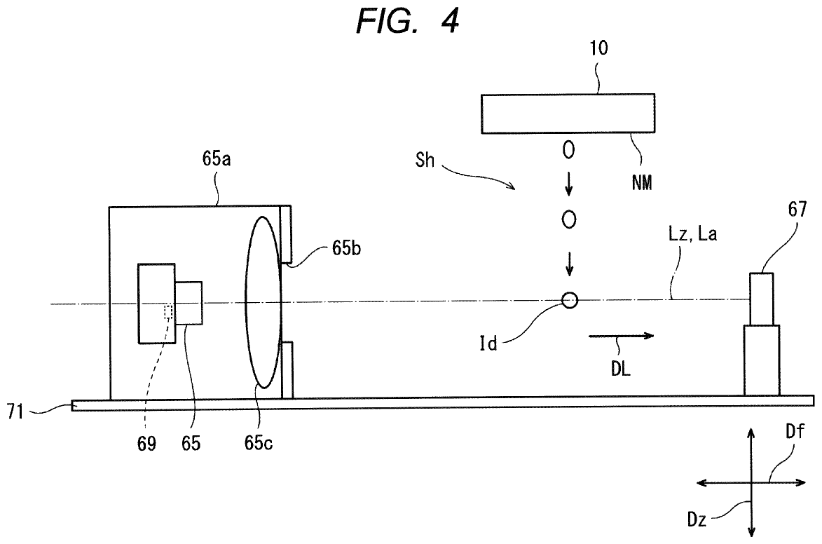

FIG. 4 shows a mode in which a laser light Lz is irradiated to an ink droplet that is being ejected from the ejection head 10 and is flying. The light source 65 and the first detection element 67 are arranged at the position of the receiving unit 54 or the purge unit 50 in the movement direction Ds. More specifically, the light source 65 and the first detection element 67 are arranged such that the receiving unit 54 or the purge unit 50 is interposed between the light source 65 and the first detection element 67 in the conveyance direction Df.

The light source 65 is, for example, a laser diode. As shown in FIG. 4, the light source 65 emits laser light Lz of a particular wavelength region. Specifically, the light source 65 irradiates the laser light Lz toward a flying space Sh in which an ink droplet ejected from the ejection head 10 flies. In the present embodiment, the laser light Lz is an example of light.

The light source 65 is disposed on one side with respect to the position of the ejection head 10 in an optical axis direction DL (emission direction) of an optical axis La of the laser light Lz emitted from the light source 65. Examples of the light source 65 include a light emitting diode (LED) and a semiconductor laser (LD). The light source 65 is housed in a box-shaped light source housing 65a. The light source housing 65a has a slit 65b on the side of the emission direction of the laser light Lz emitted from the light source 65. The slit 65b allows the laser light Lz emitted from the light source 65 to pass through to the outside. In the light source housing 65a, a lens 65c is disposed so as to cover the slit 65b from the inside of the light source housing 65a. One or more lenses may be provided separately from the lens 65c. The light source housing 65a is supported by a frame 71 extending in the optical axis direction DL of the laser light Lz.

The first detection element 67 is disposed on the other side with respect to the position of the ejection head 10 in the optical axis direction DL. The first detection element 67 generates a current based on the received laser light Lz and outputs a current signal to a current-voltage conversion circuit (not shown). The current-voltage conversion circuit converts the current signal received from the first detection element 67 into a voltage signal and outputs the voltage signal to an amplifier circuit. The amplifier circuit amplifies the voltage signal received from the current-voltage conversion circuit and outputs the amplified voltage signal to the controller 20. The first detection element 67 is supported by the frame 71 in a similar manner to the light source housing 65a.

In the above configuration, the laser light Lz emitted from the light source 65 passes through the lens 65c, and then is emitted to an ink droplet that is ejected from the ejection head 10 and are flying in the flying space Sh. The first detection element 67 detects the amount of received light of the laser light Lz emitted from the light source 65 and passing through the flying space Sh, and outputs a signal corresponding to the detected amount of received light to the controller 20. The controller 20 receives a signal output from the first detection element 67. The controller 20 performs an ejection malfunction detection process of the nozzle based on the received signal corresponding to the amount of received light. In the ejection malfunction detection process, an ejection malfunction such as an abnormal speed of an ink droplet, an abnormal volume of an ink droplet, and a deviation of an ink droplet is detected. The deviation means that the ink droplet flies in a direction different from the normal flying direction.

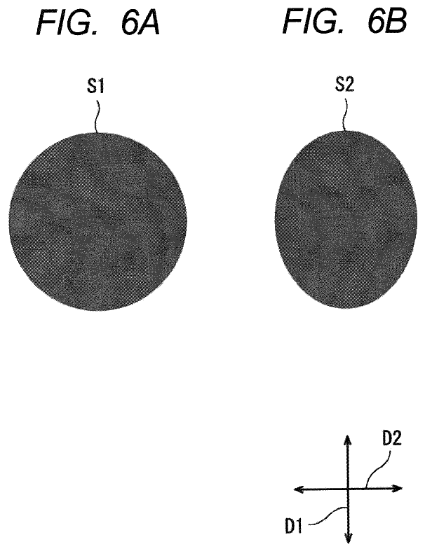

FIG. 5 shows a mode in which a light reception surface 68 of the first detection element 67 is arranged inclined with respect to an emission surface 66 of the light source 65. FIG. 6A shows an example of an effective light reception surface S1 of the light reception surface 68 viewed from the emission surface 66 side in a case where the light reception surface 68 is disposed without being inclined to a second direction D2. FIG. 6B shows an example of an effective light reception surface S2 of the light reception surface 68 viewed from the emission surface 66 side in a case where the light reception surface 68 is disposed to be inclined at a particular angle to the second direction D2.

As shown in FIG. 5, the light source 65 has the emission surface 66 from which the laser light Lz is emitted. The first detection element 67 has the light reception surface 68 for detecting the amount of received light related to the laser light Lz emitted by the light source 65.

The light reception surface 68 is disposed to be relatively inclined in a particular inclination direction with respect to a state of facing the emission surface 66 without inclination. As shown in FIG. 5, the light reception surface 68 faces in an inclination direction Dt. By disposing the light reception surface 68 in an inclined manner in this way, the reflected light reflected by the light reception surface 68 is less likely to be incident on the light source 65. The inclination direction Dt is opposite to the ejection head 10 with respect to a first direction D1 parallel to the ejection direction of the ink droplet. That is, the inclination direction Dt is a direction away from the ejection head 10. Thus, the light reception surface 68 is inclined in a direction opposite to the nozzle surface NM of the ejection head 10 with respect to an imaginary line Lv connecting the light emission surface 66 and the light reception surface 68. In other words, the light reception surface 68 is inclined in a direction away from the nozzle surface NM. The imaginary line Lv is an imaginary line passing through the light source 65 and parallel to the optical axis direction DL.

The light reception surface 68 is disposed to be inclined with respect to the emission surface 66 in any one of the first direction D1, the second direction D2, or both the first direction D1 and the second direction D2. The second direction D2 is a direction perpendicular to both the first direction D1 and the direction along the imaginary line Lv. In a mode in which the light reception surface 68 is disposed to be inclined with respect to the emission surface 66 in both the first direction D1 and the second direction D2, the light reception surface 68 is inclined two dimensionally. FIG. 5 illustrates an example in which the light reception surface 68 is disposed to be inclined in the first direction D1 with respect to the emission surface 66.

In the embodiment, the light reception surface 68 may be disposed to be inclined with respect to the emission surface 66, or the emission surface 66 may be disposed to be inclined with respect to the light reception surface 68. Alternatively, both the emission surface 66 and the light reception surface 68 may be inclined. In the example of FIG. 5, the light reception surface 68 is disposed to be inclined in a particular inclination direction with respect to a state where the emission surface 66 and the light reception surface 68 face each other without inclination. The first detection element 67 may be disposed in a state where the light reception surface 68 is inclined by an operator before the ejection malfunction detection process is started, or the light reception surface 68 may be inclined by rotating the first detection element 67 by the rotation device 57 as described later.

In FIG. 5, a relationship a<L×tan θ is satisfied where “θ” is an angle (inclination angle) formed by the imaginary line Lv and the inclination direction Dt in which the light reception surface 68 faces; “a” is a half of an aperture size of the slit 65b, measured along an intersection line between the slit 65b and an imaginary plane defined by the imaginary line Lv and the inclination direction Dt; and “L” is a length between the slit 65b and the light reception surface 68 (that is, a length between the slit 65b and a point on the light reception surface 68 at which the imaginary line Lv intersects). In the example of FIG. 5, the imaginary plane defined by the imaginary line Lv and the inclination direction Dt coincides with the drawing sheet of FIG. 5.

As an example, a case where the light reception surface 68 is inclined in the second direction D2 is considered. The second direction D2 is a direction perpendicular to both the first direction D1 and the direction along the imaginary line Lv. As shown in FIG. 6A, when the light reception surface 68 is disposed without being inclined in the second direction D2, the effective light reception surface S1 of the light reception surface 68 as viewed from the emission surface 66 side is relatively large. The effective light reception surface is a surface of the light reception surface 68 that receives the laser light Lz, that is, a surface that detects the laser light Lz. As shown in FIG. 6B, when the light reception surface 68 is disposed to be inclined at a particular angle in the second direction D2, the effective light reception surface S2 of the light reception surface 68 as viewed from the emission surface 66 side is smaller than the effective light reception surface S1 described above. The same applies to a case where the light reception surface 68 is inclined in the first direction D1 (FIG. 5). Thus, it is considered to prevent an excessive decrease in the effective light receiving area due to excessive inclination of the light reception surface 68 while reducing the reflected light reflected by the light reception surface 68 incident on the light source 65. Hereinafter, a specific example will be described.

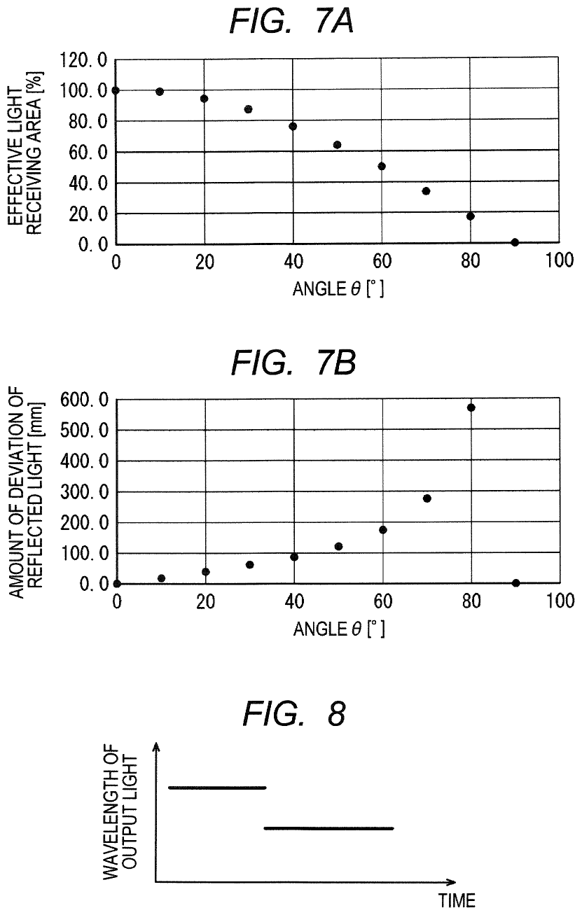

FIG. 7A shows a relationship between the effective light receiving area of the light reception surface 68 and the angle θ of the light reception surface 68. FIG. 7B shows a relationship between the amount of deviation of the light reflected from the light reception surface 68 and the angle θ of the light reception surface 68. The angle θ in FIGS. 7A and 7B indicates the inclination angle of the light reception surface 68 when the light reception surface 68 is inclined as shown in FIG. 5.

As shown in FIG. 7A, it is understood that the effective light receiving area decreases as the angle θ increases. As shown in FIG. 7B, it is understood that the amount of deviation of the reflected light increases as the angle θ increases. The amount of deviation of the reflected light is a distance between a position where the reflected light reflected by the light reception surface 68 is irradiated on the wall of the light source housing 65a and the upper or lower end of the slit 65b of the light source housing 65a. As described above, the technical viewpoint is to reduce the reflected light incident on the light source 65 while reducing a decrease in the effective light reception surface due to excessive inclination of the light reception surface 68 (that is, while reducing a decrease in the determination accuracy in the ejection malfunction detection process). From this technical viewpoint, the light reception surface 68 is inclined such that the effective light receiving area of the light reception surface 68 is 90% or more of the effective light receiving area in the state where the emission surface 66 and the light reception surface 68 face each other without inclination. For example, when a distance L between the slit 65b and the light reception surface 68 is 100 mm, the angle θ is approximately 30 degrees, for example.

Next, a calibration process for determining the inclination of the light reception surface 68 with respect to the light emission surface 66 will be described. The calibration process is a process for determining an inclination (relative inclination) of the light reception surface 68 with respect to the light emission surface 66. In the calibration process, the light reception surface 68 is inclined by rotating the first detection element 67 by the rotation device 57.

Structural examples of the rotation device 57 will be described. In a first structural example of the rotation device 57, a rotation shaft is fixed at the rotation center of the first detection element 67, and the rotation shaft is rotated by the rotation motor 56 so as to incline (tilt) the light reception surface 68 of the first detection element 67. In a second structural example of the rotation device 57, a link is disposed at a position shifted from the rotation center of the first detection element 67, and the link is pushed and pulled by the rotation motor 56 so as to incline (tilt) the light reception surface 68 of the first detection element 67.

The calibration process is performed at the time of manufacturing assembly and after shipment, for example. The calibration process is performed when the amount of noise included in the output value of the first detection element 67 is large or the amount of received light detected by the first detection element 67 is small. Specifically, the controller 20 performs the calibration process when the amount of noise included in the output value of the first detection element 67 (that is, the amount of noise caused by the reflected light) when the laser light Lz is emitted by the light source 65 is greater than or equal to a first threshold, or when the amount of light received by the first detection element 67 when the laser light Lz is emitted by the light source 65 is smaller than or equal to a second threshold.

The light received by the first detection element 67 includes both (i) the light that directly comes from the light source 65 and (ii) the light that is reflected by the first detection element 67, is incident on the light source 65, is again reflected by the light source 65, and is incident on the first detection element 67. In a case where the light source 65 and the first detection element 67 face each other without inclination, the amount of the reflected light increases. The amount of noise is obtained by subtracting the amount of light that directly comes from the light source 65, from the amount of light that is received by the first detection element 67. The amount of light that directly comes from the light source 65 may be preliminarily calculated and stored in a memory, for example.

In the calibration process, the controller 20 performs an inclination change process, an initial value acquisition process, and an inclination determination process. In the inclination change process, the controller 20 changes the inclination of the light reception surface 68 with respect to the light emission surface 66. In this case, the controller 20 rotates the first detection element 67 by the rotation device 57 so as to change the angle θ by a particular step amount. In the example of FIG. 5, the rotation device 57 may rotate the first detection element 67 counterclockwise. In this way, the light reception surface 68 is rotated counterclockwise and inclined.

In the initial value acquisition process, the controller 20 sets the angle θ, which is the inclination when the amount of noise is the largest during the inclination change process, as the initial value. In this case, the controller 20 acquires the amount of noise included in the output value of the first detection element 67 each time the angle θ is changed in the inclination change process. Then, the controller 20 extracts the amount of noise having the maximum value from the plurality of acquired amounts of noise, and stores the angle θ corresponding to the extracted amount of noise having the maximum value in a memory as the initial value. Normally, the amount of noise often becomes the largest when the light reception surface 68 faces the emission surface 66 without inclination.

In the inclination determination process, the controller 20 determines the inclination when the amount of noise is smaller than or equal to a third threshold when the inclination change process is performed, by using the initial value as a reference. In this case, the controller 20 rotates the first detection element 67 by the rotation device 57 so as to change the angle θ by a particular step angle. The controller 20 acquires the amount of noise included in the output value of the first detection element 67 each time the angle θ is changed in the inclination determination process. When the amount of noise is smaller than or equal to the third threshold, the controller 20 determines the angle θ at this time as the angle θ that is acquired in the ejection malfunction detection process. Then, the ejection malfunction detection process is performed in a state where the inclination angle of the light reception surface 68 is set to the determined angle θ.

Next, a correction process relating to a detection signal of the first detection element 67 will be described. In the correction process, the change in the wavelength of the output light by the light source 65 is considered.

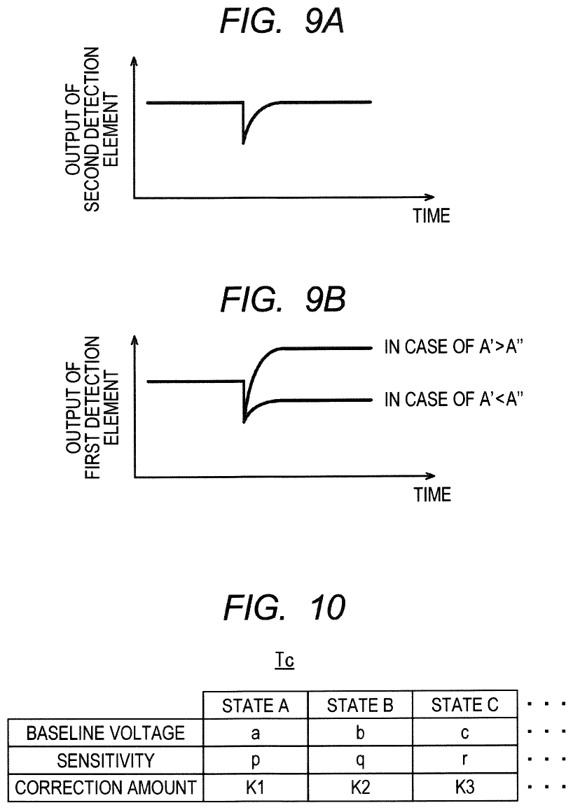

FIG. 8 shows an example of a relationship between a wavelength of the laser light Lz, which is output light output by the light source 65, and time. FIG. 9A shows an example of a relationship between signal outputs by the second detection element 69 and time. FIG. 9B shows an example of a relationship between signal outputs by the first detection element 67 and time.

When a laser diode is used as the light source 65, for example, the wavelength of the output light from the light source 65 may change due to instability of the temperature of the light source 65 immediately after the light source 65 is activated, incidence of external light on the light source 65, and so on. Specifically, as shown in FIG. 8, the wavelength of the output light of the light source 65 may hop over time. Thus, as shown in FIG. 9A, the voltage value of the signal output from the second detection element 69 having wavelength-dependent sensitivity also hops to the lower side. Thereafter, as shown in FIG. 9A, the controller 20 controls an emission operation of the output light of the light source 65 such that the output light of the light source 65 becomes constant. The sensitivity is based on a product of the illuminance at the ink droplet position by the output light of the light source 65 and the illuminance gradient along the optical axis direction of the output light. It is assumed that A′ is the sensitivity of the second detection element 69, and that A″ is the sensitivity of the first detection element 67 having wavelength-dependent sensitivity in a similar manner to the second detection element 69. In a case where the sensitivity A′>the sensitivity A″, the voltage value of the output signal from the first detection element 67 increases greatly after the hop as shown in FIG. 9B. In a case where the sensitivity A′<the sensitivity A″, the voltage value of the output signal from the first detection element 67 increases slightly after the hop as shown in FIG. 9B. In this way, the voltage value of the output signal of the first detection element 67 changes due to change of the wavelength of the output light by the light source 65. The reason is as follows. In a case where the sensitivity A′ of the second detection element 69 is high, the second detection element 69 is highly sensitive even to slight wavelength shifts caused by reflected light, and performs control to increase the output of the light source 65 to compensate for the shift. Consequently, the voltage of the first detection element 67 increases substantially.

Thus, in order to avoid a decrease in the determination accuracy in the ejection malfunction detection process when the wavelength of the output light from the light source 65 changes, the following correction process is performed. FIG. 10 shows a correction table Tc in which a correction amount for the correction process is stored for each state. The correction table Tc is stored in a memory.

In the present embodiment, the controller 20 performs a reception process and the correction process. In the reception process, the controller 20 receives a detection signal and a state determination signal from the first detection element 67. The detection signal is a signal that is output from the first detection element 67 when the laser light Lz is emitted from the light source 65 and an ink droplet is ejected from the ejection head 10. The state determination signal is a signal before or after the detection signal is output, and is a signal that is output from the first detection element 67 when no ink droplet is ejected from the ejection head 10. The controller 20 may perform the reception process after a particular time elapses from the start of emission of the laser light Lz by the light source 65.

As shown in FIG. 10, the correction table Tc stores a correction amount (a correction amount for correcting the detection signal) for each baseline voltage (which is the state determination signal) and each sensitivity of the first detection element 67. That is, each correction amount is stored in association with the state determination signal and the sensitivity of the first detection element 67. The baseline voltage in FIG. 10 may be a single value or may have a range including an upper limit and a lower limit. In the correction process, the controller 20 performs correction of multiplying the detection signal by a correction amount in accordance with the state determination signal and the sensitivity. Although the number of baseline voltages is three in FIG. 10 for convenience of description, the number of baseline voltages stored in the correction table Tc may be changed as appropriate.

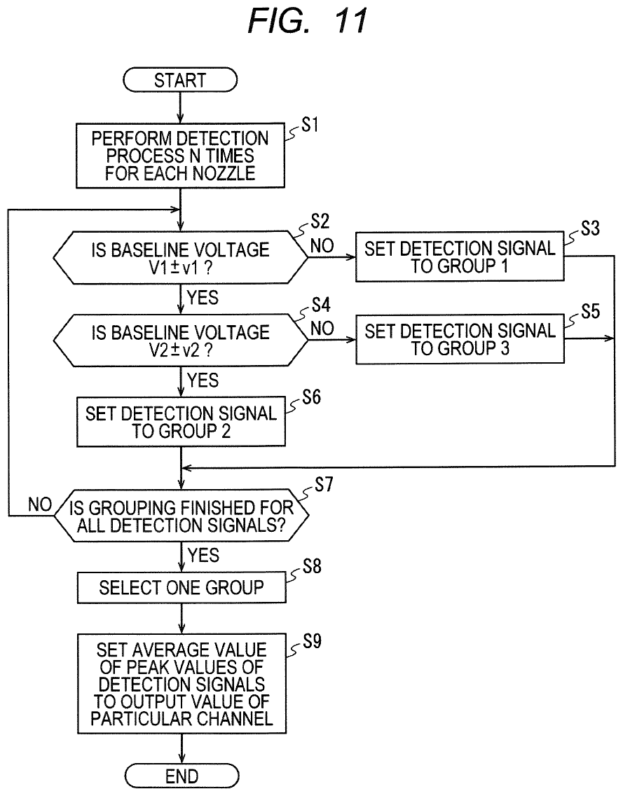

Instead of the correction process described above, the controller 20 may perform the following process. FIG. 11 illustrates an example of a process including a grouping process.

In the present aspect, the controller 20 performs a multiple-time ejection process, a multiple reception process, a grouping process, a group selection process, and an output value acquisition process. In FIG. 11, the multiple-time ejection process and the multiple reception process are collectively referred to as a process of step S1. Hereinafter, “step” will be abbreviated as “S”.

In the multiple-time ejection process, as shown in FIG. 11, the controller 20 causes ink droplets to be ejected a plurality of times per nozzle 121 in a state where the laser light Lz is emitted from the light source 65 (S1). In the multiple reception process, the controller 20 receives the detection signal and the baseline voltage, which is the state determination signal, from the first detection element 67 in response to each ejection by one nozzle 121 in the multiple-time ejection process (S1).

Next, in the grouping process, based on a comparison between a voltage value (for example, a peak value) of the baseline voltage and thresholds, the controller 20 classifies detection signals corresponding to the baseline voltage into a plurality of groups. In the example of FIG. 11, the controller 20 determines whether the baseline voltage is within a range of V1±v1 (S2). When the baseline voltage is not within the range of V1±v1 (No in S2), the controller 20 sets the detection signal corresponding to the baseline voltage to belong to group 1, for example (S3). When the baseline voltage is within the range of V1±v1 (Yes in S2), the controller 20 determines whether the baseline voltage is within a range of V2±v2 (S4). When the baseline voltage is not within the range of V2±v2 (No in S4), the controller 20 sets the detection signal corresponding to the baseline voltage to belong to group 3, for example (S5). When the baseline voltage is within the range of V2±v2 (Yes in S4), the controller 20 sets the detection signal corresponding to the baseline voltage to belong to group 2, for example (S6). In the example of FIG. 11, the number of groups is three for convenience of description, but the number of groups may be changed as appropriate.

Then, the controller 20 determines whether the grouping has been finished for all the detection signals (S7). When the grouping is not finished for all the detection signals (No in S7), the controller 20 returns the processing to S2 and repeats the subsequent steps. When the grouping of all the detection signals is finished (Yes in S7), the controller 20 performs the group selection process.

In the group selection process, the controller 20 selects one group from a plurality of groups based on a particular condition (S8). Specifically, the controller 20 selects a group having the largest number of detection signals as the particular condition from the plurality of groups.

Next, in the output-value acquisition process, the controller 20 sets, for example, an average value of peak values of the detection signals belonging to the selected group as an output value of the detection signal corresponding to the one nozzle 121 (particular channel) in the ejection malfunction detection process (S9). The above-described process also reduces a decrease in determination accuracy in the ejection malfunction detection process when the wavelength of the output light from the light source 65 changes.

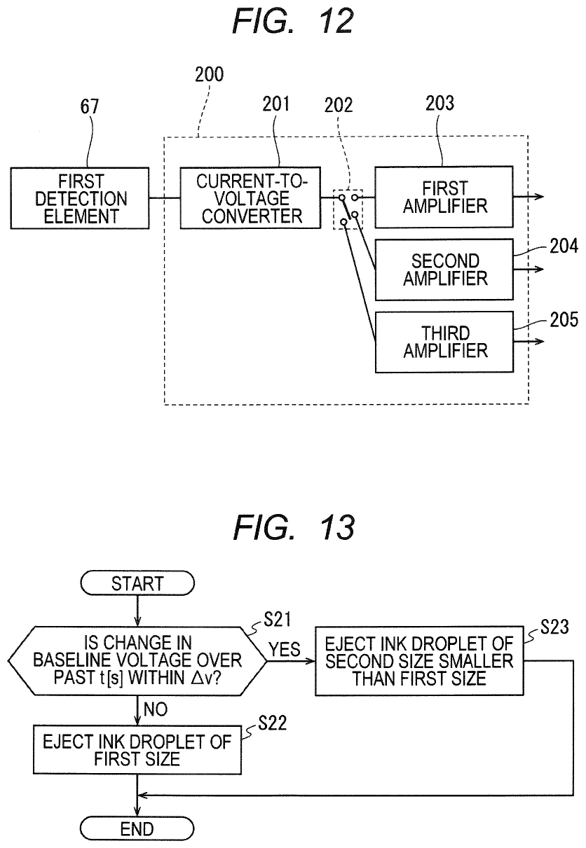

Alternatively, instead of performing the correction process described above, the following configuration may be adopted. FIG. 12 illustrates the configuration of a signal amplification unit (signal amplification circuit) 200.

The liquid droplet ejection apparatus 100 includes the signal amplification unit 200, as shown in FIG. 12. The signal amplification unit 200 includes a current-to-voltage converter 201, a switch 202, a first amplifier 203, a second amplifier 204, and a third amplifier 205. The current-to-voltage converter 201 converts the detection signal of the first detection element 67 from a current value to a voltage value. The first amplifier 203, the second amplifier 204, and the third amplifier 205 amplify the output signal output from the current-to-voltage converter 201 at respective amplification factors. The amplification factors of the amplifiers are different.

In the present embodiment, the controller 20 receives the detection signal and the state determination signal described above from the first detection element 67. Based on the state determination signal, the switch 202 switches the amplifier to be connected to the current-to-voltage converter 201 among the first amplifier 203, the second amplifier 204, and the third amplifier 205. The selected amplifier, among the first amplifier 203, the second amplifier 204, and the third amplifier 205, amplifies the output signal output from the current-to-voltage converter 201 at a particular amplification factor. The output signal amplified at the particular amplification factor is used in the ejection malfunction detection process. The above process prevents a decrease in determination accuracy in the ejection malfunction detection process during wavelength change of the output light from the light source 65.

Alternatively, instead of performing the correction process described above, the controller 20 may perform the following process. FIG. 13 illustrates an example of an ink droplet ejection process.

In this example, in the ejection malfunction detection process, the controller 20 causes the nozzle 121 to eject ink droplets of a first size (for example, extra-large droplets) before a particular time elapses, and causes the nozzle 121 to eject ink droplets of a second size smaller than the first size (for example, medium droplets) after the particular time elapses. Specifically, as shown in FIG. 13, the controller 20 determines whether a change in the baseline voltage over the past t seconds is within a particular Av (S21). When the change in the baseline voltage is not within the particular Av (S21: No), the controller 20 causes the nozzle 121 to eject an ink droplet of the first size (S22). When the change in the baseline voltage is within the particular Av (S21: Yes), the controller 20 causes the nozzle 121 to eject an ink droplet of the second size smaller than the first size (S23). By ejecting an ink droplet of the first size before the particular time elapses, the level of the detection signal is increased. This prevents a decrease in determination accuracy in the ejection malfunction detection process when the wavelength of the output light output from the light source 65 changes.

As described above, in the liquid droplet ejection apparatus 100 of the present embodiment, the light reception surface 68 is disposed to be inclined in the particular inclination direction Dt with respect to a state where the emission surface 66 and the light reception surface 68 face each other without inclination. This reduces reflected light, which is the laser light Lz emitted from the light source 65 and reflected by the light reception surface 68, being incident on the light source 65. By reducing the reflected light incident onto the light source 65, the likelihood of discrete changes in the oscillation mode of the light source 65 (that is, discrete changes in wavelength) is reduced. Thus, the voltage output by the first detection element 67 having wavelength dependence is less likely to include noise due to changes in the wavelength. Thus, the ejection malfunction detection process for the nozzle 121 is performed based on the voltage output by the first detection element 67 with reduced noise. This reduces the likelihood of erroneous determination of ejection malfunction.

In the present embodiment, the inclination direction Dt is a direction opposite to the ejection head 10 with respect to the first direction D1 parallel to the ejection direction of the ink droplets. Thus, the light reception surface 68 is inclined in a direction opposite to the nozzle surface NM of the ejection head 10 with respect to the imaginary line Lv connecting the emission surface 66 and the light reception surface 68. This reduces the reflected light that is reflected by the light reception surface 68, then reflected by the nozzle surface NM, and then enters the light source 65.

In the present embodiment, the light reception surface 68 is disposed to be inclined with respect to the emission surface 66 such that a<L×tan θ is satisfied, which reduces the reflected light that is reflected by the light reception surface 68 and enters the light source 65 through the slit 65b of the light source housing 65a.

In the present embodiment, the light reception surface 68 is inclined such that the effective light receiving area of the light reception surface 68 is 90% or more of the state where the emission surface 66 and the light reception surface 68 face each other without inclination. This avoids the difficulty in performing ejection detection with high accuracy due to the effective light receiving area of the light reception surface 68 being less than 90% of the state where the emission surface 66 and the light reception surface 68 face each other without inclination.

When the light source 65 and the first detection element 67 are used over time, the inclination of the first detection element 67 with respect to the light source 65 may change due to vibrations, for example. In the present embodiment, the calibration process described above enables determination of an inclination that reduces the amount of noise included in the output value of the first detection element 67.

In the present embodiment, in the inclination determination process, the controller 20 determines the inclination of the light reception surface 68 when the noise amount becomes smaller than or equal to the third threshold when performing the inclination change process based on the initial value. This enables easy determination of an inclination that reduces the amount of noise included in the output value of the first detection element 67.

When the light source 65 such as a laser diode is used, the wavelength of the output light from the light source 65 may change due to the temperature instability of the light source 65 immediately after startup. In the present embodiment, even if the wavelength of the output light changes, correction is performed using an appropriate correction amount for the detection signal based on the state determination signal, which reduces the likelihood of erroneous determination in the ejection detection process. This eliminates the need for preheating to stabilize the temperature of the light source 65 before the ejection detection process, resulting in energy saving and a rapid ejection detection.

In the present embodiment, since the correction amount stored in the memory is used, the correction amount need not be calculated. This reduces the need for high-specification controller 20, thereby enabling cost reduction of the liquid droplet ejection apparatus 100.

In the present embodiment, the controller 20 may perform the reception process after a particular time elapses from the start of emission of the laser light Lz by the light source 65. This reduces the temperature instability of the light source 65, and reduces a change of the wavelength of the output light from the light source 65. As a result, the detection signal and the state determination signal with reduced noise are obtained.

In the present embodiment, the controller 20 may perform the multiple-time ejection process, the multiple reception process, the grouping process, the group selection process, and the output value acquisition process described above. This enables the ejection malfunction detection process to be performed early without waiting for a particular time to elapse from the start of emission of the laser light Lz by the light source 65 to stabilize its temperature.

In the present embodiment, the first amplifier 203, the second amplifier 204, and the third amplifier 205 may amplify the output signal output from the current-to-voltage converter 201 at respective particular amplification factors. This reduces the likelihood of erroneous determination in the ejection malfunction detection process based on the amplified detection signal even if the voltage output by the first detection element 67 changes due to its wavelength dependence.

In the ejection malfunction detection process of the present embodiment, before the particular time elapses, for example, before the temperature of the light source 65 stabilizes, an ink droplet of the first size is ejected, thereby increasing the amplitude and signal width of the detection signal. This reduces the likelihood of erroneous determinations in the ejection malfunction detection process based on the detection signal with increased amplitude and signal width even if the voltage output by the first detection element 67 changes due to its wavelength dependence. After the particular time elapses, for example, after the temperature of the light source 65 stabilizes, an ink droplet of the second size, which is smaller than the first size, is ejected. This reduces the cost increase related to the ejection amount of ink droplets.

In the above embodiment, the calibration process involves causing the light reception surface 68 to be inclined with respect to the emission surface 66 by using the rotation device 57, but the disclosure is not limited to this. The light reception surface 68 may be inclined with respect to the emission surface 66 by rotating the light source 65, the first detection element 67, or both the light source 65 and the first detection element 67.

In the above embodiment, the controller 20 performs the correction process by using the correction amount stored in the correction table Tc, but the disclosure is not limited to this. The controller 20 may perform the correction process by using a particular calculation formula.

In the above embodiment, the platen supporting the print medium W is moved in the conveyance direction Df to convey the print medium W in the conveyance direction Df, but the disclosure is not limited to this. A configuration in which the print medium W is conveyed in the conveyance direction Df by a conveyance roller may be adopted.

In the above embodiment, an inkjet head that ejects ultraviolet-curable ink droplets is exemplified as the ejection head 10, but the configuration of the ejection head 10 is not limited to this. An ejection head that ejects normal ink droplets, which are not ultraviolet-curable, may be adopted. In the case where the ejection head ejects normal ink droplets, the ultraviolet irradiation device 40 is unnecessary.

While the disclosure has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the disclosure, and not limiting the disclosure. Various changes may be made without departing from the spirit and scope of the disclosure. Thus, the disclosure is intended to embrace all known or later developed alternatives, modifications, variations, improvements, and/or substantial equivalents. Some specific examples of potential alternatives, modifications, or variations in the described disclosure are provided as appropriate.

1. A liquid droplet ejection apparatus comprising:
an ejection head including a nozzle surface facing in a first direction, the nozzle surface including a nozzle configured to eject a liquid droplet;
a light source including an emission surface facing in an optical axis direction crossing the first direction, the emission surface being configured to emit light toward a flying space in which the liquid droplet ejected from the nozzle flies;
a light sensor including a light reception surface, the light reception surface being configured to detect an amount of light that is emitted from the light source and passes through the flying space; and
a controller configured to perform an ejection malfunction detection of:
detecting an amount of light by the light sensor when the liquid droplet is ejected from the ejection head and the light is emitted from the light source; and
detecting an ejection malfunction of the nozzle based on the amount of light detected by the light sensor,
the light reception surface being inclined to face in an inclination direction with respect to a state where the emission surface and the light reception surface face each other without inclination.

2. The liquid droplet ejection apparatus according to claim 1, wherein the inclination direction is a direction away from the ejection head.

3. The liquid droplet ejection apparatus according to claim 1, further comprising a light source housing accommodating the light source, the light source housing having a slit for allowing the light emitted from the light source to pass through to outside the light source housing,
wherein a relationship a<L×tan θ is satisfied where “θ” is an angle formed by the inclination direction and an imaginary line passing through the light source and parallel to the optical axis direction; “a” is a half of an aperture size of the slit, measured along an intersection line between the slit and an imaginary plane defined by the imaginary line and the inclination direction; and “L” is a distance between the slit and the light reception surface.

4. The liquid droplet ejection apparatus according to claim 1, wherein the light reception surface is inclined with respect to the emission surface in the first direction or in a second direction crossing the first direction and the optical axis direction, an effective light receiving area of the light reception surface being 90% or more of a state where the emission surface and the light reception surface face each other without inclination.

5. The liquid droplet ejection apparatus according to claim 1, further comprising a rotation device configured to rotate at least the light source or the light sensor to a state where the light reception surface is inclined with respect to the emission surface,
wherein the controller is configured to:
perform a calibration for determining an inclination of the light reception surface with respect to the emission surface in a first case or in a second case, the first case being a case where an amount of noise included in an output value of the light sensor when light is emitted by the light source is greater than or equal to a first threshold, the second case being a case where the amount of light detected by the light sensor when light is emitted by the light source is smaller than or equal to a second threshold.

6. The liquid droplet ejection apparatus according to claim 5, wherein the controller is configured to, in the calibration:
change the inclination of the light reception surface with respect to the emission surface;
set, as an initial value, the inclination when the amount of noise becomes largest while changing the inclination;
again change the inclination using the initial value as a reference; and
set, as a determined value, the inclination when the amount of noise becomes smaller than or equal to a third threshold.

7. The liquid droplet ejection apparatus according to claim 1, wherein the controller is configured to:
perform reception of a detection signal and a state determination signal from the light sensor, the detection signal being a signal that is output from the light sensor when the liquid droplet is ejected from the ejection head, the state determination signal being a signal that is output from the light sensor when the liquid droplet is not ejected from the ejection head, the state determination signal being a signal that is output before and after the detection signal; and
perform correction on the detection signal by using a correction amount, the correction amount depending on the state determination signal.

8. The liquid droplet ejection apparatus according to claim 7, further comprising a memory configured to store the correction amount in association with the state determination signal.

9. The liquid droplet ejection apparatus according to claim 7, wherein the controller is configured to perform reception of the detection signal and the state determination signal after a particular time elapses from start of emission of the light by the light source.

10. The liquid droplet ejection apparatus according to claim 1, wherein the controller is configured to:
eject the liquid droplet a plurality of times from the nozzle;
receive a detection signal and a state determination signal from the light sensor in response to each of the plurality of times of ejection from the nozzle, the detection signal being a signal that is output from the light sensor when the liquid droplet is ejected from the ejection head, the state determination signal being a signal that is output from the light sensor when the liquid droplet is not ejected from the ejection head, the state determination signal being a signal that is output before and after the detection signal;
perform grouping of detection signals received in the plurality of times of ejection into a plurality of groups, the grouping being performed based on a comparison between a voltage value of the state determination signal corresponding to the detection signal and one or more threshold;
select one group from the plurality of groups based on a particular condition; and
acquire an average of peak values of detection signals included in the selected group as an output value of the detection signal for the nozzle.

11. The liquid droplet ejection apparatus according to claim 1, further comprising an amplifier,
wherein the controller is configured to receive a detection signal and a state determination signal from the light sensor, the detection signal being a signal that is output from the light sensor when the liquid droplet is ejected from the ejection head, the state determination signal being a signal that is output from the light sensor when the liquid droplet is not ejected from the ejection head, the state determination signal being a signal that is output before and after the detection signal; and
wherein the amplifier is configured to amplify the detection signal by an amplification factor determined based on the state determination signal.

12. The liquid droplet ejection apparatus according to claim 1, wherein the controller is configured to:
cause the ejection head to eject the liquid droplet of a first size from the nozzle before a particular time elapses; and
cause the ejection head to eject the liquid droplet of a second size from the nozzle after the particular time elapses, the second size being smaller than the first size.
